(19) United States
(12) Patent Application Publication
(10) Pub. No.: US 2011/0300442 A1
(43) Pub. Date: Dec. 8, 2011

(54) NOVEL NANOSCALE SOLUTION METHOD FOR SYNTHESIZING LITHIUM CATHODE ACTIVE MATERIALS

(75) Inventor: Biying Huang, Henderson, NV (US)

(73) Assignee: Infinity Energy (Hong Kong) Co., Limited, Wanchai (HK)

(21) Appl. No.: 12/792,207

(22) Filed: Jun. 2, 2010

(51) Int. Cl. H01M 4/131; H01M 4/60

(52) U.S. Cl. 429/212; 252/182.1

(57) ABSTRACT

The present invention relates to a solution based method for preparing an nano scale electroactive metal polyanion or a mixed metal polyanion comprising reacting metal sulfate—M(SO₄)ₓ and/or other soluble metal salts, here M could be iron, cobalt, manganese, nickel or mixtures thereof, with a solution of sodium hydroxide with addition of solution of ammonium hydroxide, in the presence of water, drying the nano-intermediate M(OH)₂ or M₁M₂(OH)₂ or M₁M₂M₃(OH)₂, or MO(OH) or M₁M₂O(OH) or M₁M₂M₃O(OH), mixing the dried intermediate with a soluble lithium precursor and soluble PO₄ containing precursor and a soluble polymer carbon, well mixed the mixture, and then removing said solvent at a temperature and for a time sufficient to remove the solvent and form an essentially dried mixture; and heating said mixture at a temperature and for a time sufficient to produce an electroactive metal polyanion or electroactive mixed metal polyanion. It is another object of the invention to provide electrochemically active materials produced by said methods. The electrochemically active materials so produced are useful in making electrodes and batteries.

### FIELD OF THE INVENTION

This invention is in the general field of a processing method for preparing cathode materials for secondary electrochemical cells.

### Abbreviations:

The following abbreviations are used: EC=ethylene carbonate; DI=de-ionized water; DMC=dimethyl carbonate; PVDF=polyvinylidene fluoride; RT=room temperature; XRD=x-ray diffraction.

### BACKGROUND OF THE INVENTION

Various different cathode materials have been investigated in the rechargeable battery industry. LiCoO₂ is the most common cathode material used today in commercial Li ion batteries because of the virtue of its high working voltage and long cycle life. Although LiCoO₂ is the cathode material widely used in portable rechargeable battery applications, the high cost, toxicity and relatively low thermal stability are features where the material has serious limitations as a rechargeable battery cathode material. These limitations have stimulated a number of researches to investigate methods of treating the LiCoO₂ to improve its thermal stability. However, the safety issue due to low thermal stability is still the critical limitation for LiCoO₂ cathode material, especially when the battery is used in high charging-discharging rate conditions. Therefore, LiCoO₂ is not considered suitable as cathode material in rechargeable battery for transportation purposes and this has stimulated searches for alternative cathode material for the use with electric vehicles and hybrid electric vehicles as well as for energy storage system.

LiFePO₄ has been investigated as a very attractive alternative cathode material in rechargeable batteries due to its high thermal stability which makes it suitable for high rate charge-discharge applications in transportation tools and power tools. Batteries using LiFePO₄ as the cathode material have achieved market penetration in electric bicycles, scooters, wheel chairs and power tools. However, the current LiFePO₄ materials in the market are still suffered from high impedance which will eventually limit the cycling life and high rate charge/discharge capability of the battery made from LiFePO₄. The impedance of the materials is highly related to synthesis methods and formulation of the materials. In addition, most known methods were disclosed in U.S. Patents of U.S. Pat. No. 5,910,382, U.S. Pat. No. 6,528,003, U.S. Pat. No. 6,723,470, U.S. Pat. No. 6,730,281, U.S. Pat. No. 6,815,122, U.S. Pat. No. 6,884,544, and U.S. Pat. No. 6,913,855. Most of manufacturing methods in these prior arts such as solid state reaction and sol-gel methods are still suffered from high processing cost and inhomogeneous composition of materials, which results in the low performance of the battery materials. The nanometer particles of lithium iron phosphates were achieved through milling process. Therefore, the objective of this invention is to provide the liquid solution synthesis method without the milling process for LiMPO₄ cathode materials with low impedance, high energy density, high life cycle as well as low processing cost due to good composition uniformity of the products, where M can be Fe, Mn, Co, Ni or other metals or mixture thereof, and some P can also be replaced by Si and other elements, O can also be replaced by F and other elements. The present invention is a preferred method for producing highly homogeneous composition of multiple substitutions of a complex compound or composites with various coating or doping of different materials. The present invention is further preferred for an effective control of large scale production of nanometer particles size of LiMPO₄ based materials.

### SUMMARY OF THE INVENTION

Embodiments of the present invention are directed to uniform solution reaction and cost effective methods of generating nanometer scale of active cathode materials of an ordered or modified olivine structure lithium metal phosphate based materials with superior electrochemical properties. Specific embodiments, as will be described below, are for use in a secondary electrochemical cell.

In the various embodiments of the invention, a uniform solution reaction and cost effective process of generating a nanometer-scale composite active cathode of an ordered or modified olivine structure LiₓM_{y}PO₄ (M, a metal or a mixture of two or more metals and x, y in a range from 0.5 to 1.5) comprises (1) reacting soluble metal salts such as sulfate—M(SO₄)ₓ, here M could be iron, cobalt, manganese, nickel or mixture thereof, with a solution of sodium hydroxide with addition of solution of ammonium hydroxide, in the presence of water, water solution, or other solvent, (2) collecting nanometer precipitates by filtering or evaporation, (3) drying the nano-intermediate precipitates of M(OH)₂ or M₁M₂(OH)₂ or M₁M₂M₃(OH)₂, or MO(OH) or M₁M₂O(OH) or M₁M₂M₃O(OH), (4) mixing the dried intermediate precipitates with a solution of lithium precursor and a solution of PO₄ containing precursor, (5) drying the mixture, and (6) calcining the mixture in an inert or reducing environment to obtain the final LiMPO₄ based materials.

In various embodiments of the invention, a uniform solution reaction and cost effective process of generating a nanometer-scale composite active cathode of an ordered or modified olivine structure LiₓM_{y}ZO₄, where M, a metal or a mixture of two or more metals, x and y in a range from 0.5 to 1.5, and the Z in the ZO₄ is selected from the group consisting of P, Si elements and mixture thereof, and it is soluble in the solvent, and the precursors of these elements can be LiH₂PO₄, NH₄H₂PO₄, (NH₄)₂HPO₄, NH₄HSiO₃, (NH₄)₂SiO₃, and (NH₄)₄₋ₓHₓSiO₄ (x=0, 1, 2, or 3).

In the various embodiments of the invention, the lithium precursor is selected from the group consisting of a hydroxide salt and other soluble salt.

In the various embodiments of the invention, the drying is carried out in the air at a temperature between a lower limit of approximately 100° K. and an upper limit of approximately 450° K.

In the various embodiments of the invention, the carbon precursor is selected from the group consisting of carbon black, Super P® carbon, one or more sugar molecules selected from the group consisting of monosaccharides, and polysaccharides, including one or more sugar units selected from the group consisting of ribose, glucose and mannose, and one or more oxygen-carbon containing polymers selected from the group consisting of polyether, polyglycol, polyester, poly butylene, polybutylene, poly-6-hydroxyhexanoate, poly-3-hydroxyoctanoate, and poly-3-hydroxyphenylhexanoic acid.

In the various embodiments of the invention, the calcination temperature is between a lower limit of approximately 600° K. and an upper limit of approximately 1300K.

In the various embodiments of the invention, the simplified and cost effective process of generating a nano-composite active cathode and an ordered or modified olivine type structure LiₓM_{y}ZO₄ comprises reacting metal sulfate—M(SO₄)ₓ, here M could be iron, cobalt, manganese, nickel or mixtures thereof, with a solution of sodium hydroxide with addition of solution of ammonium hydroxide, in the presence of water, drying the reaction nano-intermediate M(OH)₂ or M₁M₂(OH)₂ or M₁M₂M₃(OH)₂, or MO(OH) or M₁M₂O(OH) or M₁M₂M₃O(OH) mixing the dried intermediate with a soluble lithium precursor and a soluble PO₄ containing precursor and calcining the mixture in an inert or reducing environment. In the various embodiments of the invention, the dried M(OH)₂ or M₁M₂(OH)₂ or M₁M₂M₃(OH)₂, or MO(OH) or M₁M₂O(OH) or M₁M₂M₃O(OH) intermediate is mixed with a soluble lithium precursor and soluble PO₄ containing precursor and/or Si containing precursor solution such as LiH₂PO₄, Li₂HPO₄, NH₄H₂PO₄, (NH₄)₂HPO₄, NH₄HSiO₃, (NH₄)₂SiO₃, (NH₄)₄₋ₓHₓSiO₄ (x=0, 1, 2, or 3) etc, and mixture thereof.

### BRIEF DESCRIPTION OF THE DRAWINGS

The numerous advantages of the present invention may be better understood by those skilled in the art by reference to the accompanying figures in which:

FIG. 1 shows the X-ray diffraction (XRD) pattern of (A) the above synthesized material and (B) the reference pattern for olivine structure LiFePO₄;

FIG. 2 is a plot of voltage versus capacity which shows (A) the charging and (B) the discharging profile of this electrochemical cell at 0.5 C rate from 4.1 V to 2.0 V. A capacity of approximately 160 mAh/g can be observed;

FIG. 3 is a plot of capacity versus cycle number which shows the cycling at 0.5 C charging and discharging rates of an electrochemical cell with this synthesized material as the cathode;

FIG. 4 shows the high rate performance of this reaction vs. solid-state reaction method sample tested at 10 C and 15 C, the solid-state reaction is only half of the capacity of the material synthesized by this invention method;

FIG. 5 shows the X-ray diffraction pattern (XRD) of (A) the above synthesized material and (B) the reference pattern for olivine structure LiFePO₄;

FIG. 6 shows the X-ray diffraction pattern (XRD) of (A) the above synthesized material and (B) the reference pattern for olivine structure LiFePO₄;

FIG. 7 shows the X-ray diffraction pattern (XRD) of (A) the above synthesized sample and (B) the reference pattern for olivine structure LiFePO₄;

FIG. 8 shows the X-ray diffraction pattern (XRD) of (A) the above synthesized sample and (B) the reference pattern for olivine structure LiFePO₄;

FIG. 9 shows the X-ray diffraction pattern (XRD) of (A) the above synthesized sample and (B) the reference pattern for olivine structure LiFePO₄; and

FIG. 10 shows the X-ray diffraction pattern (XRD) of (A) the above synthesized material and (B) the reference pattern for olivine structure LiFePO₄.

### DETAILED DESCRIPTION OF THE INVENTION

Reference will now be made in detail to the presently preferred embodiments of the invention, examples of which are illustrated in the accompanying drawings.

### Introduction and Overview

The invention is illustrated by the way of example and not by the way of limitation in the figures of the accompanying drawings in which like references indicate similar elements. It should be noted that references to ‘an’ or ‘one’ embodiment in this disclosure are not necessarily to the same embodiment, and such references mean at least one.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description will be presented in chemical synthesis terms, such as precursors, intermediates, product, and so forth, consistent with the manner commonly employed by those skilled in the art to convey the substance of their work to others skilled in the art. As well understood by those skilled in the art, these are labels, and may otherwise be manipulated through synthesis conditions.

Various operations will be described as multiple discrete steps in turn, in a manner that is most helpful in understanding the present invention, however, the order of description should not be construed as to imply that these operations are necessarily order dependent.

Various embodiments will be illustrated in terms of exemplary classes of precursors. It will be apparent to one skilled in the art that the present invention can be practiced using any number of different classes of precursors, not merely those included here for illustrative purposes. Furthermore, it will also be apparent that the present invention is not limited to any particular mixing paradigm.

The performance of battery electrode materials is highly dependent on the morphology, particle size, purity, and conductivity of the materials. Different material synthesis processes can readily produce materials with different morphology, particle size, purity, or conductivity. As a result, the performance of the battery materials is highly dependent on the synthesis process.

In order to improve the rechargeable battery performance and reduce the synthesis and production costs, different processing methods have been explored to synthesize LiFeMPO₄ type materials. Currently, the dominant production method is the solid state method. However, the processing cost of this method is very high. In addition, as metal doping is needed, for example to control discharge voltage and improve conductivity, the conventional solid state method usually mixes dopant metal precursor(s) with iron precursor in solid forms. This kind of solid state mixing cannot achieve a homogeneous mixing of the dopant with other precursors. As a result, the quality and performance of the synthesized materials is negatively affected.

The safety/material stability/high cost issues of LiCoO₂ cathode materials and the materials uniformity/cycle life/high cost issues in the conventional method of producing the LiFeMPO₄ type materials significantly limit the available market for Li ion rechargeable batteries. This situation is exacerbated by the pursuit of low production cost means of manufacturing high performance of LiFeMPO₄ materials. The present invention addresses what is needed for a low cost and scalable manufacturing method of producing nano LiMPO₄ based materials with high quality and high performance.

### Methods of Making Cathode Materials for a Secondary Electrochemical Cell

In the various embodiments of the invention, low cost metal sulfate—M(SO₄)ₓ is used as the precursor to generate nano-intermediate phase of M(OH)₂ or M₁M₂(OH)₂ or M₁M₂M₃(OH)₂ or MO(OH) or M₁M₂O(OH) or M₁M₂M₃O(OH) as multi-metal compounds used for producing homogeneous LiMPO₄ based materials, such as LiFeₓMn₁₋ₓPO₄, LiFeₓNi_{y}Mn_{1-x-y}PO₄, or LiCoₓNi_{y}Mn_{1-x-y}PO₄. This can be very attractive as it can produce high performance materials with low cost. This is essentially because of the low cost of MSO₄, such as FeSO₄ and NiSO₄ compared to iron oxalate and Ni oxalate. A method using MSO₄ as the precursor produce pure LiNi_{1/3}CO_{1/3}Mn_{1/3}O₂ is well known, but is not used to produce M(OH)₂ or M₁M₂(OH)₂ or M₁M₂M₃(OH)₂ or (MO(OH) or M₁M₂O(OH) or M₁M₂M₃O(OH) for making LiFeMPO₄ based materials such as LiFeₓMn₁₋ₓPO₄, LiFeₓNi_{y}Mn_{1-x-y}PO₄, or LiCoₓNi_{y}Mn_{1-x-y}PO₄. Further, the current methods for producing LiFePO₄, LiFeₓMn₁₋ₓPO₄, LiFeₓNi_{y}Mn_{1-x-y}PO₄, or LiCoₓNi_{y}Mn_{1-x-y}PO₄ have complicated processing steps. The numerous processing steps result in a high production cost and also it is difficult for fine control. These issues present in the reported processes to be adopted as a large scale manufacturing process. The solution process developed in the present invention is a preferred method for low cost and large scale nanometer manufacture of LiFePO₄ based materials to address the reduced capacity and cycle life of inhomogeneous cathode materials. Moreover, uniformed mixing processing and nano precipitation without milling in the present invention results in a fine and homogeneous reaction precursors to simplify the process for producing nanometer particles of LiFePO₄ based materials.

In various embodiments of the invention, a simplified and cost efficient process to synthesize LiₓMZO₄ active cathode materials can be accomplished by using MSO₄ and NaOH and NH₄OH to produce M(OH)₂ or M₁M₂(OH)₂ or M₁M₂M₃(OH)₂, MO(OH) or M₁M₂O(OH) or M₁M₂M₃O(OH) then react with at least one from LiH₂PO₄, Li₂HPO₄, NH₄H₂PO₄, (NH₄)₂HPO₄, NH₄HSiO₃, (NH₄)₂SiO₃, (NH₄)₄₋ₓHₓSiO₄ (x=1, 2, or 3) and mixture thereof as the precursors. In the general formula LiₓMPO₄, where 0<x≦1, M is at least one metal selected from one of the following groups: a 1^{st} row transition metal, Z is at least one element selected from the group consisting of P and Si.

In an embodiment of the invention, a simplified process synthesizes pure LiMPO₄, where M is Fe, Mn, or Co, or Ni.

In an embodiment of the invention, a simplified process synthesizes LiMPO₄, where M is at least one metal.

In an embodiment of the invention, a simplified process synthesizes LiM(P₁₋ₓSiₓ)O₄, where M is at least one metal, and 0≦x≦1. A major advantage of this invention is the low cost due to simplified process with use of the low cost MSO₄ as precursor. This process is suitable for the mass production of cathode material. In addition, the process can produce homogeneous nano-intermediate phase of M(OH)₂ or M₁M₂(OH)₂ or M₁M₂M₃(OH)₂, MO(OH) or M₁M₂O(OH) or M₁M₂M₃O(OH) then generate LiMPO₄ because it involves the co-precipitation of the metal precursors to form a homogeneous nano-intermediate phase of M(OH)₂ or M₁M₂(OH)₂ or M₁M₂M₃(OH)₂, or MO(OH) or M₁M₂O(OH) or M₁M₂M₃O(OH). This is difficult to achieve with the conventional solid state or sol-gel methods.

In an embodiment of the invention, a method of producing LiMZO₄ active cathode materials for secondary battery comprises reacting nano-intermediate phase of M(OH)₂ or M₁M₂(OH)₂ or M₁M₂M₃(OH)₂, MO(OH) or M₁M₂O(OH) or M₁M₂M₃O(OH) with at least one soluble PO₄ containing, or Si containing precursor, and with a soluble lithium precursor and calcinating the mixture in an inert or reducing environment.

In an embodiment of the invention, a method of producing LiMZO₄ active composite cathode materials for secondary battery comprises reacting metal sulfate—M(SO₄)ₓ, here M could be iron, cobalt, manganese, nickel or mixtures thereof, with a solution of sodium hydroxide with addition of solution of ammonium hydroxide, in the presence of water, drying the reaction of nano-intermediate M(OH)₂ or M₁M₂(OH)₂ or M₁M₂M₃(OH)₂, MO(OH) or M₁M₂O(OH) or M₁M₂M₃O(OH) or mixture thereof, mixing the dried intermediate with a soluble of lithium precursor and with at least one soluble PO₄ containing precursor, or Si containing precursor selected from the group consisting of NH₄H₂PO₄, (NH₄)₂HPO₄, H₄SiO₄, NH₄HSiO₃, (NH₄)₂SiO₃, and (NH₄)₄₋ₓHₓSiO₄ (x=0, 1, 2, or 3) or mixture thereof, and calcinating the mixture in an inert or reducing environment.

In an embodiment of the invention, a method of producing LiFeMPO₄ active composite cathode materials for secondary battery comprises reacting metal sulfate—M(SO₄)ₓ, here M could be iron, cobalt, manganese, nickel or mixture thereof, with a solution of sodium hydroxide with addition of solution of ammonium hydroxide, in the presence of water, drying the reaction nano-intermediate M(OH)₂ or M₁M₂(OH)₂ or M₁M₂M₃(OH)₂, MO(OH) or M₁M₂O(OH) or M₁M₂M₃O(OH), mixing the dried intermediate and with at least one soluble PO₄ containing precursor, or Si containing precursor, and with a soluble lithium precursor selected from the group consisting of a hydroxide salt and an acetate salt and calcinating the mixture with in an inert or reducing environment.

In an embodiment of the invention, a method of producing LiMPO₄ active composite cathode materials for secondary battery comprises reacting nano-intermediate M(OH)₂ or M₁M₂(OH)₂ or M₁M₂M₃(OH)₂, MO(OH) or M₁M₂O(OH) or M₁M₂M₃O(OH), with at least one soluble PO₄ containing precursor, or Si precursor selected from the group consisting of LiH₂PO₄, Li₂HPO₄, Li₃PO₄, NH₄H₂PO₄, (NH₄)₂HPO₄, NH₄HSiO₃, (NH₄)₂SiO₃, (NH₄)₄₋ₓHₓSiO₄ (x=0, 1, 2, or 3) or mixture thereof, and with a soluble lithium precursor, adding a dopant during the reaction between the metal sulfate and NaOH/NH₄OH and calcining the mixture in an inert or reducing environment.

In an embodiment of the invention, a method of producing LiₓM_{y}ZO₄/carbon, active composite cathode materials for secondary battery comprises reacting nano-intermediate M(OH)₂ or M₁M₂(OH)₂ or M₁M₂M₃(OH)₂, MO(OH) or M₁M₂O(OH) or M₁M₂M₃O(OH) with a soluble PO₄ containing precursor or Si containing precursor and with a soluble lithium precursor, adding a dopant during the reaction between the metal sulfate and NaOH/NH₄OH wherein the dopant is selected from the group consisting of a 1st row transition metal, Al, Ga, Ge, Mg, Ca, Sr, Zr, Nb, Ta, Mo, W and a rare earth metal, and calcinating the mixture in an inert or reducing environment.

In an embodiment of the invention, a method of producing LiₓM_{y}ZO₄ active composite cathode materials for secondary battery comprises reacting nano-intermediate M(OH)₂ or M₁M₂(OH)₂ or M₁M₂M₃(OH)₂, MO(OH) or M₁M₂O(OH) or M₁M₂M₃O(OH) with a soluble PO₄ containing precursor or Si containing precursor and with a soluble lithium precursor. The nano-intermediate M(OH)₂ or M₁M₂(OH)₂ or M₁M₂M₃(OH)₂, MO(OH) or M₁M₂O(OH) or M₁M₂M₃O(OH) are added to a stirred solution of PO₄ containing precursor and/or Si containing precursor and/or C containing precursor and a soluble lithium precursor or mixture thereof. So P/Li/C or P/Si/Li/C precursors are mixed throughout with the intermediate nano-particles. The materials so produced exhibit excellent electrochemical properties.

### EXAMPLE 1

### Synthesis of LiFePO₄ Cathode Active Material

In an embodiment of the invention, LiFePO₄ can be synthesized as the following. Reagents used in this investigation included Ferro (II) sulfate, Sodium hydroxide, and ammonium hydroxide (28.5%). All solutions were prepared with deionized (DI) water which was deaerated by boiling for 10 min. A co-precipitation reactor with a 2 L jacketed reaction vessel equipped with pH and temperature controllers was used in this investigation. Reagents were added using digital peristaltic pumps, and sodium hydroxide addition was automatically controlled by the pH controller and added as required by a peristaltic pump on the reactor. Reaction contents were maintained at a temperature of 60° C., and the contents of the reactor were stirred by an overhead stirrer at 2000 rpm. Nitrogen was bubbled 80 sccm into the reactor throughout the reaction. A volume of 1 L of a 1 M NH₄OH (aq) solution made in deaerated water was heated to 60° C. The reaction proceeded with the addition of 10.0 M NH₄OH (aq) at 0.005 L/h and 2.0 M FeSO₄ at 0.035 L/h. A concentration of 5.0 M NaOH was automatically added to the reaction contents to maintain the desired pH. The rate of NaOH solution addition was near the predicted value of 0.02 L/h based on the expected co-precipitation reaction. The reaction vessel was fitted with an overflow pipe and the reaction contents were pressurized with nitrogen to ensure a constant volume during the reaction. The residence time, given by the total flow rate of the reagents and the reactor volume, was set to be 20 h. The total reaction time was 40 h. After reaction, the solid material was filtered and washed with deaerated DI water in several rinses.

The obtained material was then dried in air at RT (room temperature). The dried mixture was then mixed with a solution of a mixture of LiOH (99% purity) and NH₄H₂PO₄ (99% purity) and PEG polymer to obtain a homogeneous mixture. After removing the solvent (water), the dried mixture was calcined at the final temperature (1000° K.) in inert gas flow to obtain the final LiFePO₄ composite materials. In various embodiments of the invention, the mixture can be calcined above a lower limit of approximately 750° K. In the various embodiments of the invention, the mixture can be calcined up to an upper limit of approximately 1250° K.

A diffractometer equipped with a Cu-target X-ray tube and a diffracted beam monochromator was used to collect powder diffraction patterns of the synthesized materials.

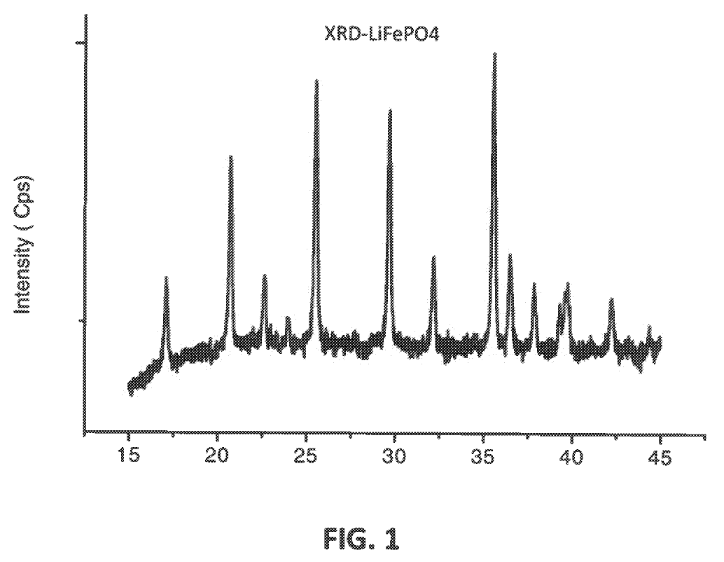

FIG. 1 shows the X-ray diffraction (XRD) pattern of (A) the above synthesized material and (B) the reference pattern for olivine structure LiFePO₄. As observed in FIG. 1 the XRD shows that the synthesized material has the same pattern as the standard LiFePO₄ olivine crystal structure without impurities.

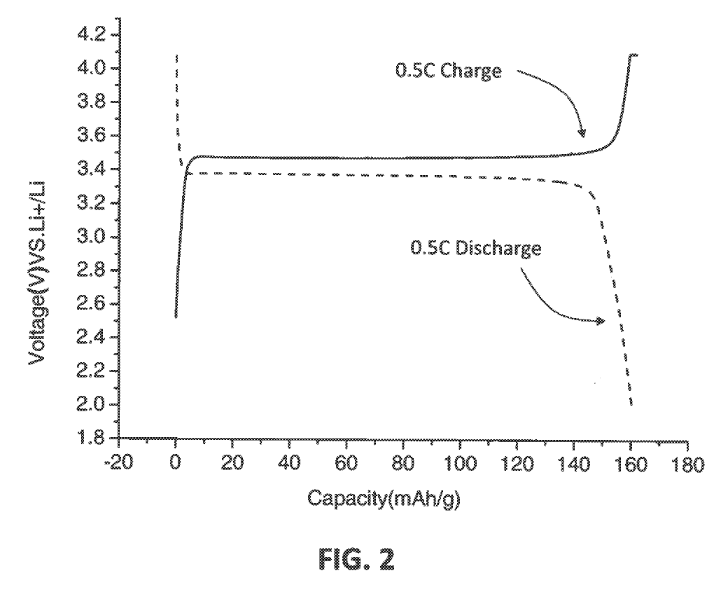

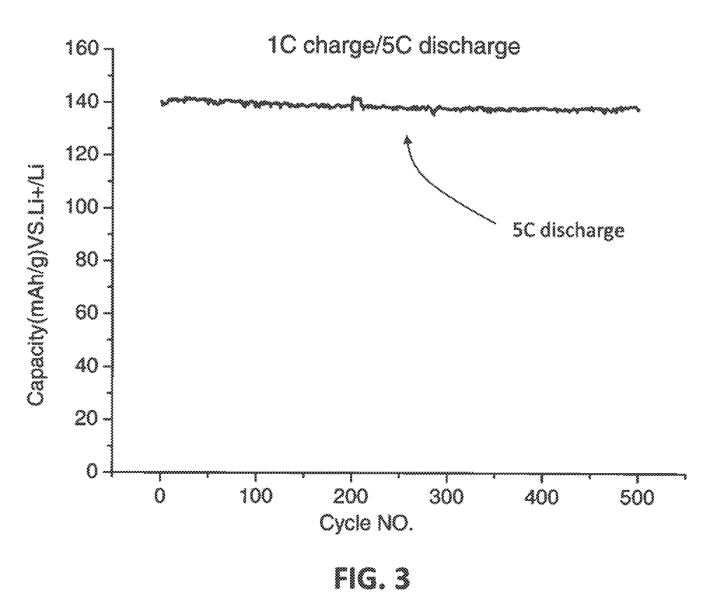

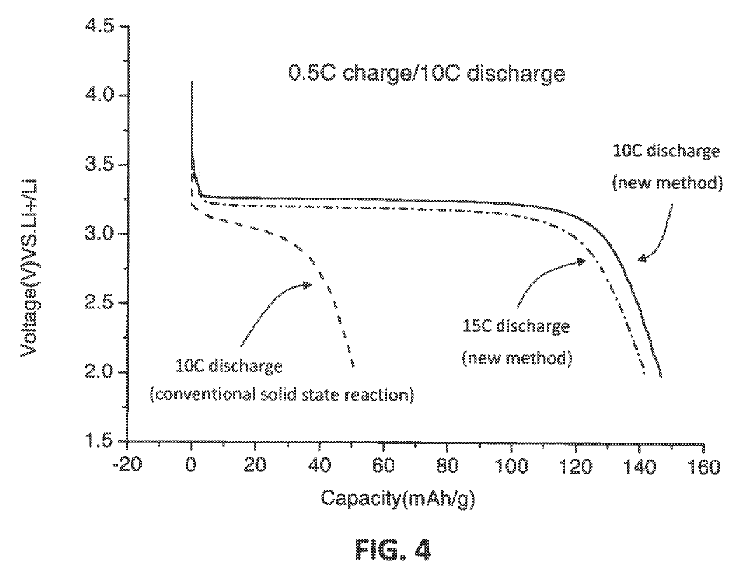

Electrochemical performance of the composite cathode materials was performed using a commercially button-cell. Cathode material was first fabricated onto aluminum foil with PVDF and Super-P carbon. Li metal was used as the anode and 1.3M LiPF₆ (in EC/DMC, 1:1 (volume ratio)) was used as the electrolyte. FIG. 2 is a plot of voltage versus capacity which shows (A) the charging and (B) the discharging profile of the electrochemical cell at 0.5 C rate from 4.1 V to 2.0 V. A capacity of approximately 160 mAh/g can be observed. FIG. 3 is a plot of capacity versus cycle number which shows the cycling at 1 C charging and 5 C discharging rates of an electrochemical cell with this synthesized material as the cathode. As shown in FIG. 3, after 100 cycles, there is no capacity loss observed. The synthesized material shows excellent cycling performance. FIG. 4 shows the cycle performance of the cell at high C rates. The capacity at 10 C rate is at 140 mAh/g ranges and at 15 C rate is at 125 mAh/g ranges. For comparison, a sample synthesized via the conventional solid state method was also tested at the same conditions. FIG. 4 shows the high rate performance of this solid-state sample at 10 C is only <60 mAh/g, which is less than half of the capacity of the material synthesized by this invention method.

### EXAMPLE 2

### Synthesis of LiFe_{0.5}Mn_{0.5}PO₄ Cathode Active Material

Reagents used in this investigation included Ferro (II) sulfate, manganese sulfate monohydrate (98%), sodium hydroxide, ammonium hydroxide (28.5%). All solutions were prepared with deionized (DI) water which was deaerated by boiling for 10 min. The reaction for the Fe_{0.5}Mn_{0.5}(OH)₂ is the same as in the example 1. After reaction, the solid material was filtered and washed with deaerated DI water in several rinses. The obtained material was then dried in air at RT.

The dried mixture was then mixed with a solution of a mixture of LiOH (Alfa Aesar, 99% purity) and NH₄H₂PO₄ (Alfa Aesar, 99% purity) and PEG polymer to obtain a homogeneous mixture. After removing the solvent (water), the dried mixture was calcined at the final temperature (1000° K.) in inert gas flow to obtain the final LiFe_{0.5}Mn_{0.5}PO₄ composite materials. In various embodiments of the invention, the mixture can be calcined above a lower limit of approximately 750° K. In the various embodiments of the invention, the mixture can be calcined up to an upper limit of approximately 1250° K.

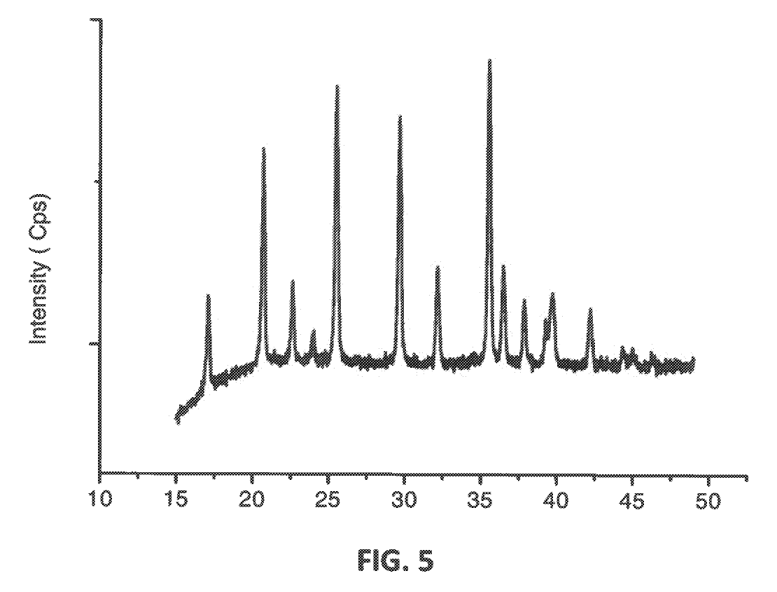

FIG. 5 shows the X-ray diffraction pattern (XRD) of (A) the above synthesized material and (B) the reference pattern for olivine structure LiFePO₄. As observed in FIG. 5 the XRD shows that the synthesized material has the same pattern as the standard LiFePO₄ olivine crystal structure without impurities.

### EXAMPLE 3

### Synthesis of LiFe_{0.33}Co_{0.33}Mn_{0.33}PO₄ Cathode Active Material

Reagents used in this investigation included Ferro (II) sulfate, manganese sulfate monohydrate (98%), cobalt sulfate heptahydrate (98%), sodium hydroxide, and ammonium hydroxide (28.5). All solutions were prepared with deionized (DI) water which was deaerated by boiling for 10 min. The reaction for the Fe_{0.33}Co_{0.33}Mn_{0.33}(OH)₂ is the same as in example 1. After reaction, the solid material was filtered and washed with deaerated DI water in several rinses.

The dried mixture was then well-mixed with a solution of a mixture of LiOH (Alfa Aesar, 99% purity) and NH₄H₂PO₄ (Alfa Aesar, 99% purity) and PEG polymer to obtain a homogeneous mixture. After removing the solvent (water), the dried mixture was calcined at the final temperature (1000° K.) in inert gas flow to obtain the final LiFe_{0.33}Co_{0.33}Mn_{0.33}PO₄ composite materials. In various embodiments of the invention, the mixture can be calcined above a lower limit of approximately 750° K. In the various embodiments of the invention, the mixture can be calcined up to an upper limit of approximately 1250° K.

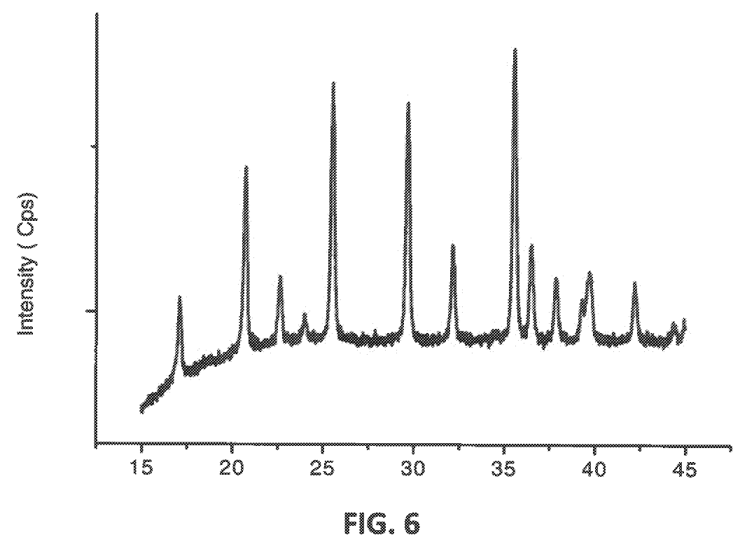

FIG. 6 shows the X-ray diffraction pattern (XRD) of (A) the above synthesized material and (B) the reference pattern for olivine structure LiFePO₄. FIG. 6 shows the synthesized material has the same XRD pattern as the standard LiFePO₄ olivine crystal structure without impurities. This indicates the successful mixing of metal into the crystal structure of olivine LiFePO₄.

### EXAMPLE 4

### Synthesis of LiFe_{0.5}Mn_{0.3}Ni_{0.2}PO₄ Cathode Active Material

Reagents used in this investigation included Ferro (II) sulfate, manganese sulfate monohydrate (98%), nickel sulfate heptahydrate (98%), sodium hydroxide, and ammonium hydroxide (28.5). All solutions were prepared with deionized (DI) water which was deaerated by boiling for 10 min. The reaction for the Fe_{0.5}Mn_{0.3}Ni_{0.2}(OH)₂ is the same as in the example 1. After reaction, the solid material was filtered and washed with deaerated DI water in several rinses.

The dried mixture was then well-mixed with a solution of a mixture of LiOH (Alfa Aesar, 99% purity) and NH₄H₂PO₄ (Alfa Aesar, 99% purity) and PEG polymer to obtain a homogeneous mixture. After removing the solvent, the dried mixture was calcined at the final temperature (1000° K.) in inert gas flow to obtain the final LiFe_{0.5}Mn_{0.3}Ni_{0.2}PO₄ composite materials. In various embodiments of the invention, the mixture can be calcined above a lower limit of approximately 750° K. In various embodiments of the invention, the mixture can be calcined up to an upper limit of approximately 1250° K.

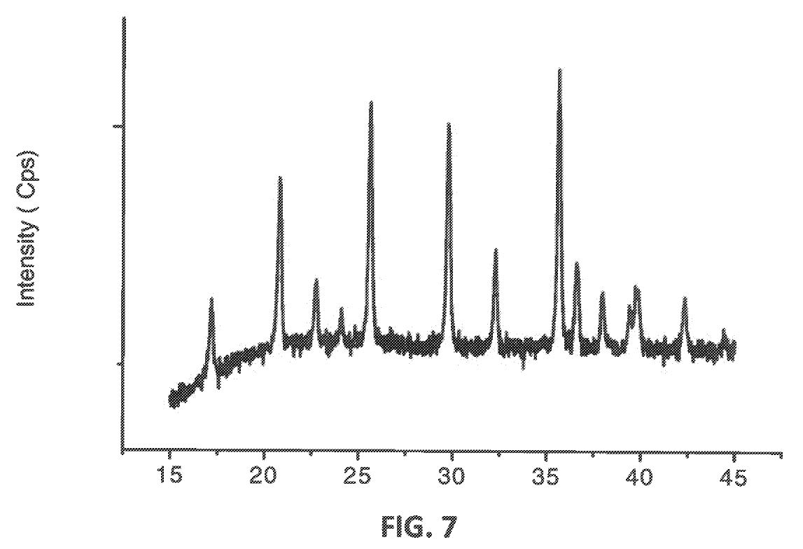

FIG. 7 shows the X-ray diffraction pattern (XRD) of (A) the above synthesized sample and (B) the reference pattern for olivine structure LiFePO₄. As observed in FIG. 7, the XRD shows that the synthesized material has the same pattern as the standard LiFePO₄ olivine crystal structure without impurities.

### EXAMPLE 5

### Synthesis of LiFe_{0.4}Co_{0.2}Mn_{0.2}Ni_{0.2}PO₄ Cathode Active Material

Reagents used in this investigation included Ferro (II) sulfate, nickel(II) sulfate hexahydrate (98%), manganese sulfate monohydrate (98%), cobalt sulfate heptahydrate (98%), sodium hydroxide, ammonium hydroxide (28.5%). All solutions were prepared with deionized (DI) water which was deaerated by boiling for 10 min. The reaction for the Fe_{0.4}Co_{0.2}Mn_{0.2}Ni_{0.2}(OH)₂ is the same as in the example 1. After reaction, the solid material was filtered and washed with deaerated DI water in several rinses.

The dried mixture was then well-mixed with a solution of a mixture of LiOH (Alfa Aesar, 99% purity) and NH₄H₂PO₄ (Alfa Aesar, 99% purity) and PEG polymer to obtain a homogeneous mixture. After mixing, the mixture was calcined at the final temperature (1000° K.) in inert gas flow to obtain the final LiFe_{0.4}Co_{0.2}Mn_{0.2}Ni_{0.2}PO₄ composite materials. In the various embodiments of the invention, the mixture can be calcined above a lower limit of approximately 750° K. In various embodiments of the invention, the mixture can be calcined up to an upper limit of approximately 1250° K.

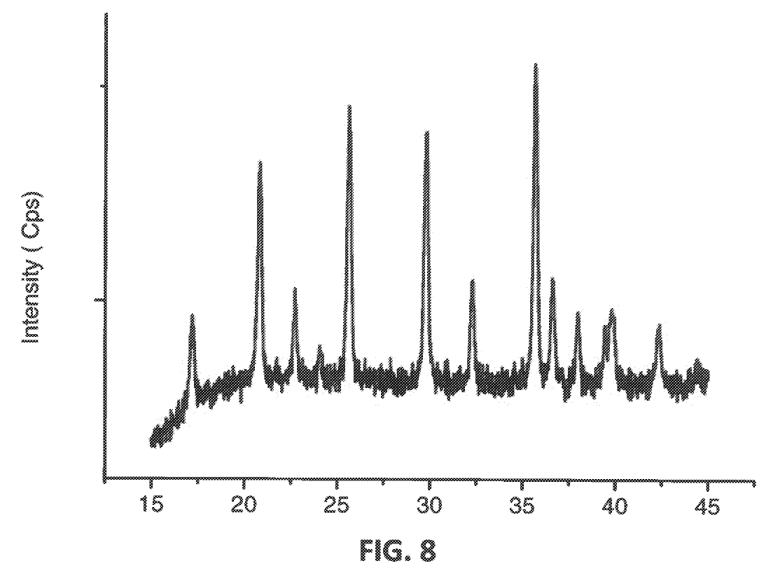

FIG. 8 shows the X-ray diffraction pattern (XRD) of (A) the above synthesized sample and (B) the reference pattern for olivine structure LiFePO₄. As observed in FIG. 8, the XRD shows that the synthesized material has the same pattern as the standard LiFePO₄ olivine crystal structure without impurities. Thus, after introduction of cobalt, nickel and manganese, the material has an olivine crystal structure without impurities. Addition of cobalt, nickel and manganese to the reaction system does not produce an extra phase(s) than the LiFePO₄ structure. This result indicates the successful introduction of cobalt, nickel and manganese into the crystal structure of olivine LiFePO₄.

### EXAMPLE 6

### Synthesis of LiNi_{0.4}Co_{0.2}Mn_{0.4}PO₄ Cathode Active Material

Reagents used in this investigation included, nickel (II) sulfate hexahydrate (98%), manganese sulfate monohydrate (98%), cobalt sulfate heptahydrate (98%). Sodium hydroxide, ammonium hydroxide (28.5). All solutions were prepared with deionized (DI) water which was deaerated by boiling for 10 min. The reaction for the Ni_{0.4}Co_{0.2}Mn_{0.4}(OH)₂ is the same as in the example 1. After reaction, the solid material was filtered and washed with deaerated DI water in several rinses.

The dried mixture was then well mixed with a solution of a mixture of LiOH (99% purity) and NH₄H₂PO₄ (99% purity) and PEG polymer to obtain a homogeneous mixture. After removing the water, the dried mixture was calcined at the final temperature (1000° K.) in inert gas flow to obtain the final LiNi_{0.4}Co_{0.2}Mn_{0.4}PO₄ composite materials. In various embodiments of the invention, the mixture can be calcined above a lower limit of approximately 750° K. In various embodiments of the invention, the mixture can be calcined up to an upper limit of approximately 1250° K.

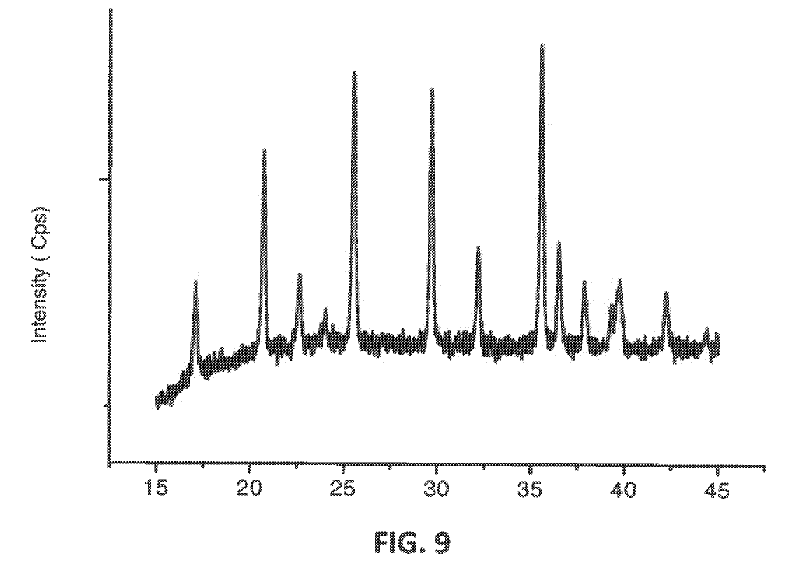

FIG. 9 shows the X-ray diffraction pattern (XRD) of (A) the above synthesized material and (B) the reference pattern for olivine structure LiFePO₄. As observed in FIG. 9 the XRD pattern shows that the synthesized material has the same pattern as the standard LiFePO₄ olivine crystal structure without impurities. This indicates successful introduction of cobalt, nickel and manganese into the crystal structure of olivine LiMPO₄.

### EXAMPLE 7

### Synthesis of LiFePO₄ Cathode Active Material

In an embodiment of the invention, LiFePO₄ can be synthesized as follows. Reagents used in this investigation included Ferro (II) sulfate. Sodium hydroxide, ammonium hydroxide (28.0-30.0%, Sigma-Aldrich). All solutions were prepared with deionized (DI) water. The reaction for the FeOOH is the same as in the example 1, except the reaction contents was bubbled and pressurized with oxgen instead of nitrogen. After reaction, the solid material was filtered and washed with DI water in several rinses.

The obtained material was then dried in air at RT. The dried mixture was then well mixed with a solution of a mixture of LiOH (Alfa Aesar, 99% purity) and NH₄H₂PO₄ (Alfa Aesar, 99% purity) and PEG polymer to obtain a homogeneous mixture. After removing the water, the mixture was calcined at the final temperature (1000° K.) in inert gas flow to obtain the final LiFePO₄ composite materials. In various embodiments of the invention, the mixture can be calcined above a lower limit of approximately 750° K. In the various embodiments of the invention, the mixture can be calcined up to an upper limit of approximately 1250° K.

### EXAMPLE 8

### Synthesis of LiFe_{0.4}CO_{0.2}Mn_{0.2}Ni_{0.2}PO₄ Cathode Active Material

Reagents used in this investigation included Ferro (II) sulfate, nickel(II) sulfate hexahydrate (98%), manganese sulfate monohydrate (98%), cobalt sulfate heptahydrate (98%), sodium hydroxide, ammonium hydroxide (28.5%). All solutions were prepared with deionized (DI) water. The reaction for the Fe_{0.4}Co_{0.2}Mn_{0.2}Ni_{0.2}OOH is the same as in the example 1, except the reaction contents was bubbled and pressurized with oxygen instead of using nitrogen After reaction, the solid material was filtered and washed with DI water in several rinses.

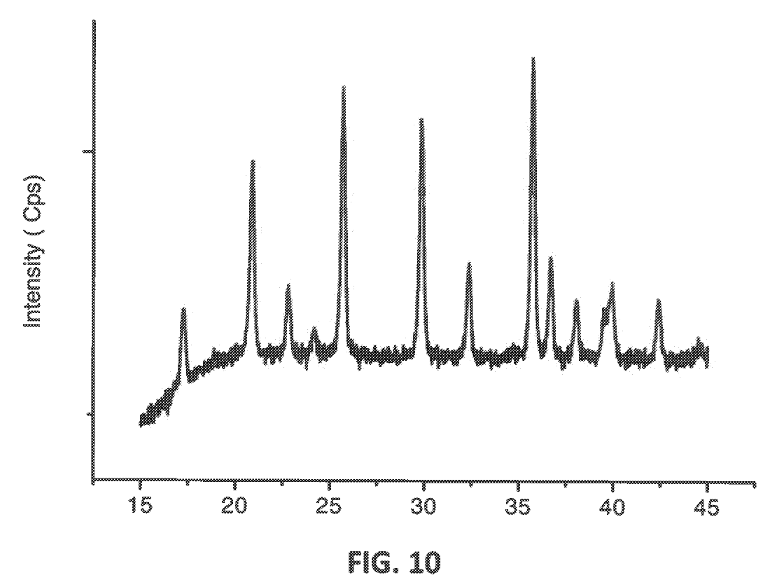

The dried mixture was then well mixed with a solution of mixture of LiOH (99%) and NH₄H₂PO₄ (99%) and PEG polymer to obtain a homogeneous mixture. After removing the 23 water, the dried mixture was calcined at the final temperature (1000° K.) in inert gas flow to obtain the final LiFe_{0.4}Co_{0.2}Mn_{0.2}Ni_{0.2}PO₄ composite materials. In the various embodiments of the invention, the mixture can be calcined above a lower limit of approximately 750° K. In various embodiments of the invention, the mixture can be calcined up to an upper limit of approximately 1250° K. FIG. 10 shows the X-ray diffraction (XRD) pattern of (A) the above synthesized material and (B) the reference pattern for olivine structure LiFePO₄. As observed in FIG. 10 the XRD shows that the synthesized material has the same pattern as the standard LiFePO₄ olivine crystal structure without impurities.

What is claimed is:

1. A method of producing a LiₓM_{y}ZO₄ composite cathode material comprising:
(a) reacting at least one soluble metal salts selected from groups of sulfate, nitrides, and halides with base compounds selected form sodium hydroxide, and ammonium hydroxide in the presence of water, water solution, or solvent;
(b) collecting the precipitates;
(c) drying the precipitates;
(d) mixing the dried precipitates with at least one soluble compound selected from PO₄ containing precursor, or Si containing precursor and a soluble lithium containing precursor;
(e) adding a soluble dopant precursor and a soluble polymer carbon precursor to the mixture, wherein the dopant is at least one M precursor; and
(f) calcinating the doped mixture in an inert or reducing environment.

2. The method of claim 1, wherein the metal sulfate precursor (or other soluble metal salt precursors) in step (a) is selected from the group consisting of iron sulfate, cobalt sulfate, nickel sulfate, and manganese sulfate.

3. The method of claim 1, wherein the phosphorous precursor in step (d) is selected from the group consisting of LiH₂PO₄, Li₂HPO₄, NH₄H₂PO₄, (NH₄)₂HPO₄ or mixture thereof

4. The method of claim 1, wherein the Si precursor in step (d) is selected from the group consisting of NH₄HSiO₃, (NH₄)₂SiO₃, and (NH₄)₄₋ₓHₓSiO₄ (x=0,1,2, or 3).

5. The method of claim 1, wherein the dopant referred to in step (e) is added in step (a).

6. The method of claim 1, wherein the drying in step (c) is carried out at a temperature between:
1) a lower limit of approximately 150° K; and
2) an upper limit of approximately 550° K.

7. The method of claim 1, wherein the lithium precursor added in step (d) is selected from the group consisting of a hydroxide salt, an acetate salt, and other salts.

8. The method of claim 1, wherein the dopant added in step (e) is selected from the group consisting of Mg, Al, Ca, Sc, Ti, V, Cr, Mn, Fe, Co, Ni, Cu, Zn, Ga, Ge, Sr, Zr, Nb, Mo, Ta, W, La, Ce, Pr, Nd, Pm, Sm, Eu, Gd, Tb, Dy, Ho, Er, Tm, Yb and Lu.

9. The method of claim 1, wherein the dopant added in step (e) is in the chemical form of one or both a metal and a salt or oxide.

10. The method of claim 1, wherein the dopant added in step (e) is the carbon precursor added in step (a).

11. The method of claim 1, wherein the carbon precursor is added before one or both the mixing step (d) and the calcining step (e).

12. The method of claim 1, wherein the carbon precursor is selected from the group consisting of PEO, PEG and other soluble polymers.

13. The method of claim 1, wherein the carbon precursor is one or more sugar molecules selected from the group consisting of monosaccharides, and polysaccharides, including one or more sugar units selected from the group consisting of ribose, arabinose, xylose, galactose, glucose and mannose.

14. The method of claim 1, wherein the carbon precursor is one or more oxygen and carbon containing polymers selected from the group consisting of a polyether, a polyglycol, a polyester, polycaprolactone, polylactide, poly butylene succinate, polybutylene succinate adipate, polybutylene succinate terephthalate, poly-hydroxypropionate, poly-hydroxybutyrate, poly-hydroxyvalerate, poly-hydroxyhexanoate, poly-3-hydroxyoctanoate, poly-3-hydroxyphenylvaleric acid and poly-3-hydroxyphenylhexanoic acid.

15. The method of claim 1, wherein the calining temperature in step (f), the calcinations is performed using conventional heating.

16. The method of claim 1, wherein the calining temperature in step (f) is between:
1) a lower limit of approximately 750° K.; and
2) an upper limit of approximately 1250° K.

17. A method of producing a, LiₓM_{y}ZO₄/carbon, composite material comprising:
(a) reacting at least one soluble metal salt precursors selected from a group of sulfates, nitrates, and halides with base selected from a group of sodium hydroxide, and ammonium hydroxide in the presence of water;
(b) drying the reaction;
(c) mixing the dried reaction with a solution of P/Si/Li containing precursors;
(d) adding a soluble polymer carbon precursor; or combine step d with step c together.
(e) calcining the mixture in an inert or reducing environment at a temperature between:
1) a lower limit of approximately 750 ° K; and
2) an upper limit of approximately 1250 ° K.

18. A cathode for use in a rechargeable electrochemical cell formed by a process comprising:
(a) reacting metal sulfate and/or other soluble metal salts with NaOH/NH₄OH
(b) drying the reaction;
(c) mixing the dried reaction with at least one soluable from PO₄ containing precursor, or Si precursor;
(d) mixing the dried mixture with a soluable lithium precursor;
(e) mixing the dried mixture with a soluble polymer carbon precursor
(f) adding a soluble dopant M, wherein M is selected from the group consisting of Mg, Al, Si, Ca, Sc, Ti, V, Cr, Mn, Fe, Co, Ni, Cu, Zn, Ga, Ge, Sr, Zr, Nb, Mo, Ta, W, La, Ce, Pr, Nd, Pm, Sm, Eu, Gd, Tb, Dy, Ho, Er, Tm, Yb and Lu, wherein the dopant is added in one or both of step (a) and step (c);
(g) calcining in an inert or reducing environment at a temperature between:
1) a lower limit of approximately 750° K; and
2) an upper limit of approximately 1250° K.

19. The cathode of claim 18, wherein the cathode is comprised in a secondary battery, the secondary battery further comprising an anode; an electrolyte; and a separator.
